(19) United States
(12) Patent Application Publication
(10) Pub. No.: US 2011/0305024 A1
(43) Pub. Date: Dec. 15, 2011

(54) LED TUBE LAMP

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/091,134

(22) Filed: Apr. 21, 2011

(30) Foreign Application Priority Data
Jun. 10, 2010 (CN) 201010195163.1

(51) Int. Cl. F21V 29/00

(52) U.S. Cl. 362/294

(57) ABSTRACT

An LED tube lamp includes a heat sink, an LED substrate, a cover fixed to the heat sink. The cover includes a first cover and a second cover, the first cover is closer to the LED substrate than the second cover, and a plurality of lenses are arranged on the surface of the first cover to refract the light beams entering into the first cover. The light beams are scattered by the lenses to enlarge the light divergence angle of the LED tube lamp.

### BACKGROUND

1. Technical Field

The present disclosure relates to light emitting diode (LED) illuminating devices and, particularly, to an LED tube lamp.

2. Description of Related Art

Compared to traditional light sources, light emitting diodes (LEDs) have advantages, such as high luminous efficiency, low power consumption, and long service life. LED lights are widely used in many applications to replace typical fluorescent lamps and neon tube lamps.

Typical LED tube lamps usually include a cylindrical tube and an LED substrate. However, in order to increase the illumination, a type of LED array including a plurality of LEDs connected in series arranged on the LED substrate is used in LED tube lamps. All the LEDs in the LED array emit light in the same direction, with this kind of LED array, the light divergence angle of LED tube lamps cannot be increased.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an LED tube lamp in accordance with an exemplary embodiment.

FIG. 2 is a cross-sectional view of the LED tube lamp of FIG. 1, taken along line II-II.

FIG. 3 is a schematic, cross-sectional view showing light beams passing through the cover of the LED tube lamp of FIG. 1.

FIG. 4 are enlarged, cross-sectional views showing different embodiments of lenses of the LED tube lamp of FIG. 1.

FIG. 5 is a diagram showing the radiation pattern of the LED tube lamp of FIG. 1 and a typical fluorescent tube lamp.

### DETAILED DESCRIPTION

Embodiments of the present disclosure are now described in detail, with reference to the accompanying drawings.

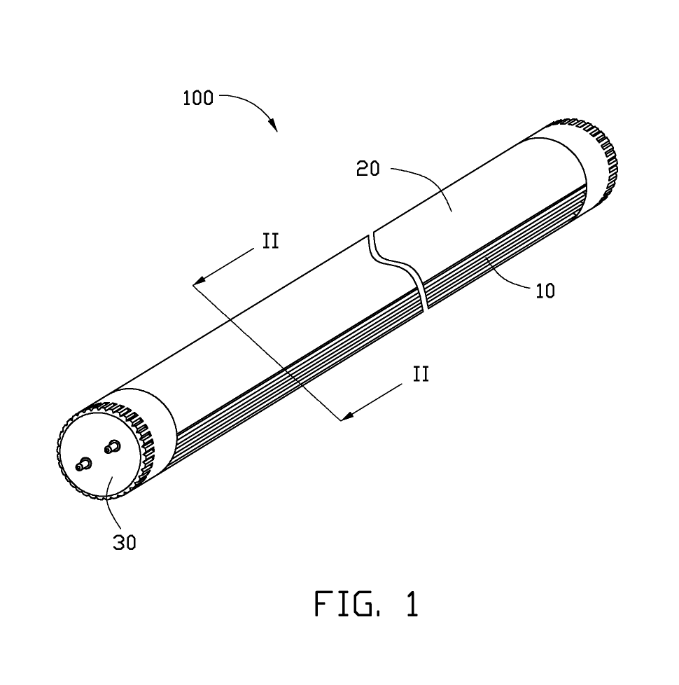

Referring to FIG. 1, an embodiment of an LED tube lamp 100 is illustrated.

The LED tube lamp 100 includes a heat sink 10, a cover 20, and a pair of connectors 30. The cover 20 is fixed to the heat sink 10, has an elongated structure, and has an arc-shaped cross section. The connectors 30 are arranged at opposite ends of the LED tube lamp 100 and are used to connect to a coupling connector (not shown), thus electrically connecting the LED tube lamp 100 to a power source.

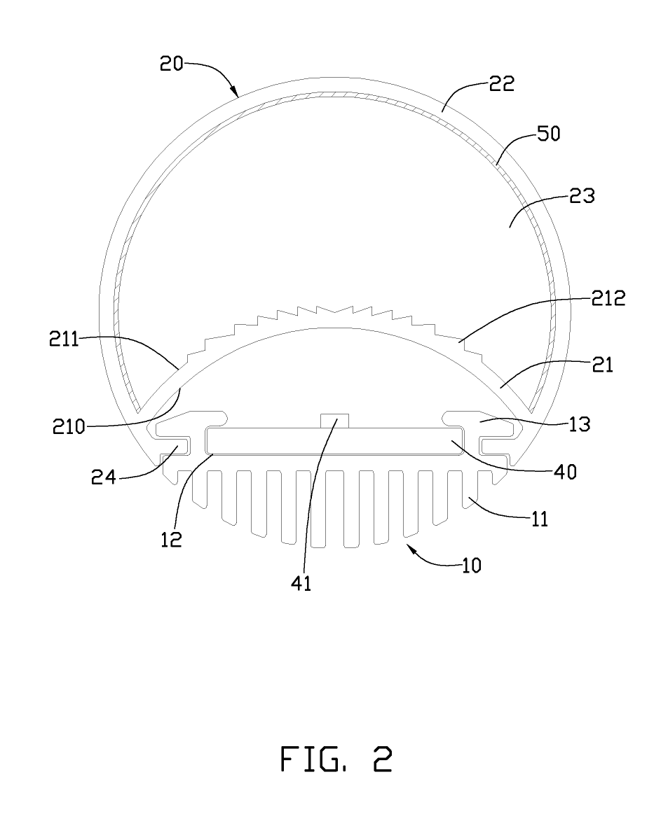

Referring to FIG. 2, the LED tube lamp 100 further includes an LED substrate 40 mounted on the heat sink 10 and electrically connected to the connector 30. A plurality of LEDs 41 are arranged on the LED substrate 40. The LEDs 41 can be chosen for having a large light divergence angle, high illumination, and/or being colored according to actual requirements.

The heat sink 10 has an elongated structure and is made of metal with good heat conductivity, such as copper or aluminum. In another embodiment, the heat sink 10 can be made of ceramic. The heat sink 10 includes a number of cooling fins 11 arranged on the bottom surface of the heat sink 10 to increase the heat dissipation area. A recess 12 is defined in the top surface of the heat sink 10 for receiving the LED substrate 40. In this embodiment, a heat-conductive medium (not shown) can be arranged between the LED substrate 40 and the inner surface of the recess 12, for transferring the heat generated by the LEDs 41 from the LED substrate 40 to the cooling fins 11. In this embodiment, the heat-conductive medium can be thermal conductive glue or heat-conductive plate. In this embodiment, the LED substrate 40 is fixed on the heat sink 10 with screws (not shown).

The heat sink 10 further includes connecting portions 13. In the embodiment, the connecting portions 13 are grooves. The cover 20 includes two projecting members 24 extending inward from the opposite ends of the cover 20. The projecting members 24 are respectively received in the connecting portions 13, thus fixing the cover 20 to the heat sink 10. The cover 20 faces the LED substrate 40, the light beams emitted from the LEDs 41 pass through the cover 20. The cover 20 includes a first cover 21 and a second cover 22, the first cover 21 is closer to the LED substrate 40 than the second cover 22. The second cover 22 has an arc-shaped cross section, with two ends fixed to opposite ends of the first cover 21. A space 23 is formed between the first cover 21 and the second cover 22.

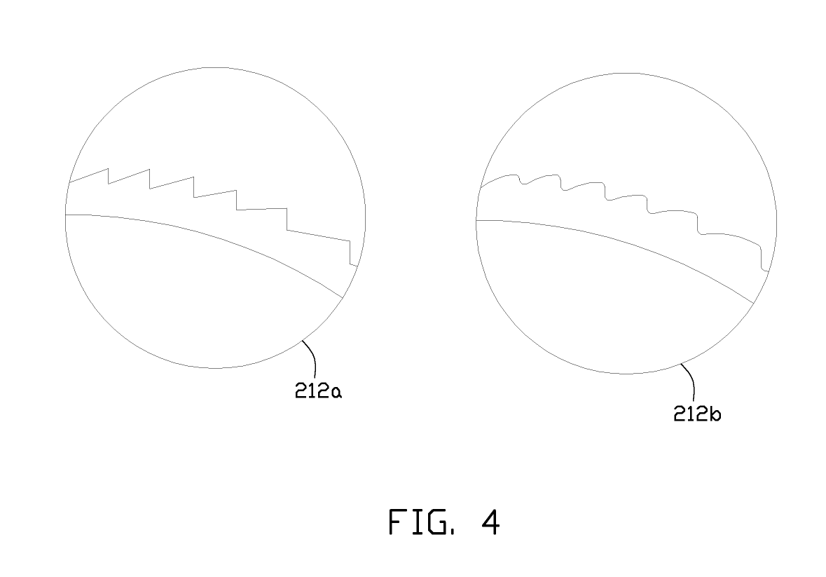

The first cover 21 is transparent and can be made of plastic or glass, such as polymethyl methacrylate (PMMA). The first cover 21 is arc-shaped in cross section, and includes an incidence surface 210 adjacent to the LED substrate 40 and an exit surface 211 opposite to the incidence surface 210. The exit surface 211 includes a number of substantially parallel elongated lenses 212 distributed side by side to each other. A number of lenses 212 are defined on the exit surface 211 to refract the light beams entered via the incidence surface 210. The cross-section of each lens 212 can be arc-shaped, triangle-shaped, triangle-shaped with fillet, zigzag-shaped, or zigzag-shaped with fillet. Referring to FIG. 4, which shows two embodiments of the lens 212, the enlarged view 212a shows that the cross-section of each lens 212 is zigzag-shaped, while the enlarged view 212b shows that the cross-section of each lens 212 is zigzag-shaped with fillet.

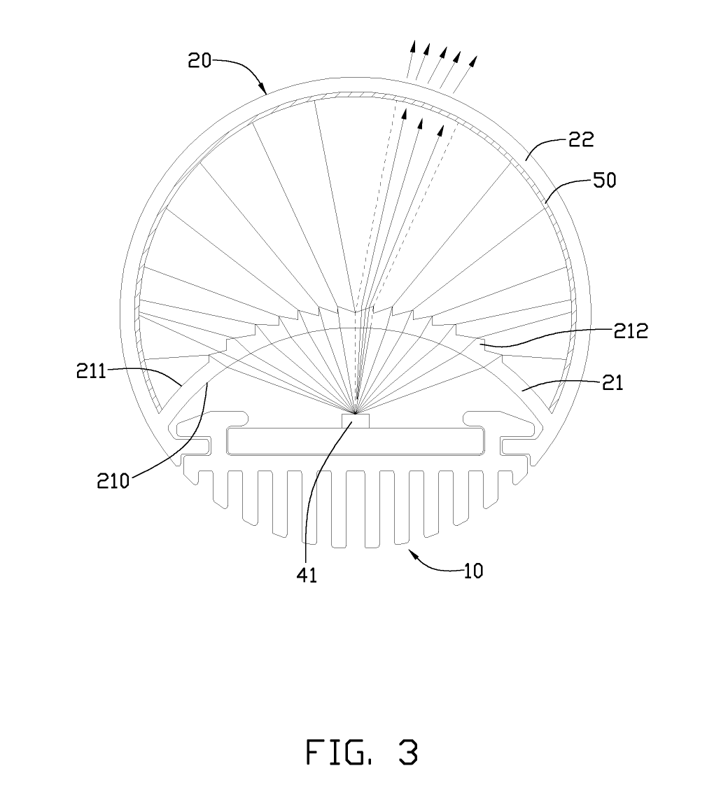

Referring to FIG. 3, the light beams entered via the incidence surface 210 are refracted by the lenses 212 and are directed substantially in a desired direction. The light beams are oriented to a direction of the vertex of each lens 212, in this embodiment, the light beams are scattered by the lenses 212 to enlarge the light divergence angle of the LED tube lamp 100. The lenses 212 can be varied in shape for pointing to proper direction according to actual requirements.

The second cover 22 can be made of transparent or translucent material mixed with light diffusion particles to improve the light scattering effect of the light. In this embodiment, a scatter layer 50 is arranged on the inner surface of the second cover 22 to scatter the light beams refracted by the lenses 212, thus achieving a homogeneous illuminating effect. The scatter layer 50 can be a coating of scatter material coated on the inner/outer surface of the second cover 22, or a film of scatter material arranged on the inner/outer surface of the second cover 22. In another embodiment, a number of accentuated portions such as protuberances and/or recesses can be defined on the inner/outer surface of the second cover 22 to scatter the light beams.

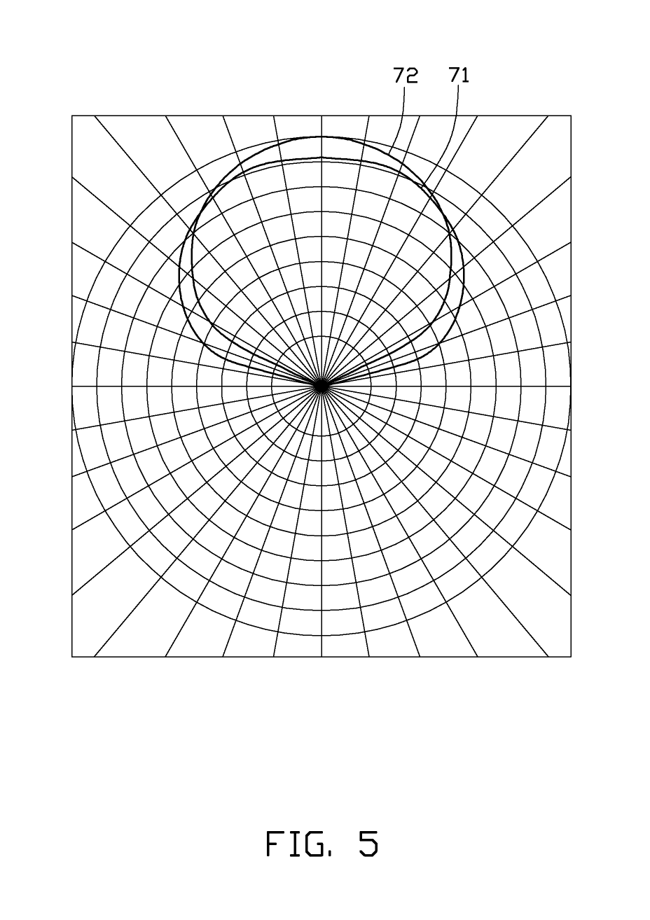

Referring to FIG. 5, as can be seen in the diagram, the first region 71 shows the radiation pattern of the LED tube lamp 100 in this embodiment, and the second region 72 shows the radiation pattern of a typical LED tube lamp. Obviously, the light divergence angle of the LED tube lamp 100 is greater than that of the existing LED tube lamp.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED tube lamp, comprising:
a heat sink;
an LED substrate mounted on the heat sink and comprising a plurality of LEDs; and
a cover fixed to the heat sink, and covering the plurality of LEDs;
wherein the cover comprises a first cover and a second cover, the first cover is closer to the LED substrate than the second cover, and a plurality of lenses are arranged on a surface of the first cover to refract the light beams entering the first cover.

2. The LED tube lamp according to claim 1, wherein the first cover comprises an incidence surface adjacent to the LED substrate and an exit surface opposite to the incidence surface, the plurality of lenses are substantially parallel elongated lenses arranged on the exit surface of the first cover.

3. The LED tube lamp according to claim 2, wherein the cross-section of the plurality of lenses is arc-shaped, triangle-shaped, triangle-shaped with fillet, zigzag-shaped, or zigzag-shaped with fillet.

4. The LED tube lamp according to claim 1, wherein the first cover is made of transparent.

5. The LED tube lamp according to claim 1, wherein the second cover is made of transparent material mixed with light diffusion particles.

6. The LED tube lamp according to claim 1, wherein the second cover is made of translucent material mixed with light diffusion particles.

7. The LED tube lamp according to claim 1, wherein the second cover further comprises a scatter layer arranged on the surface of the second cover.

8. The LED tube lamp according to claim 7, wherein the scatter layer is a coating of scatter material coated on an inner surface of the second cover.

9. The LED tube lamp according to claim 7, wherein the scatter layer is a coating of scatter material coated on an outer surface of the second cover.

10. The LED tube lamp according to claim 7, wherein the scatter layer is a film of scatter material arranged on an inner surface of the second cover.

11. The LED tube lamp according to claim 7, wherein the scatter layer is a film of scatter material arranged on an outer surface of the second cover

12. The LED tube lamp according to claim 1, wherein the heat sink defines two grooves, the cover comprises two projecting members extending inwardly from the opposite ends of the cover, the two projecting members are respectively received in the grooves.

13. The LED tube lamp according to claim 1, where a recess is defined in a top surface of the heat sink for receiving the LED substrate.

14. The LED tube lamp according to claim 1, wherein a plurality of cooling fins are arranged on a bottom surface of the heat sink.
